(19) United States
(12) Patent Application Publication
(10) Pub. No.: US 2010/0283921 A1
(43) Pub. Date: Nov. 11, 2010

(54) Multi-panel color projector using multiple light-emitting diodes as light sources

(75) Inventor: Haizhang Li, Orlando, FL (US)

Correspondence Address: RONALD J. MEETIN, ATTORNEY AT LAW, 210 CENTRAL AVENUE, MOUNTAIN VIEW, CA, 94043-4869, US

(73) Assignee: Video Display Corporation

(21) Appl. No.: 12/454,104

(22) Filed: May 11, 2009

(51) Int. Cl. H04N 5/74; G03B 21/00

(52) U.S. Cl. 348/756; 353/31; 348/E05.137

(57) ABSTRACT

A color light projector utilizes color light-emitting diodes (120, 140_{Y}, and 140_{Z} or 320_{X}, 320_{Y}, and 320_{Z}) as light sources. Digital light modulators (124 and 144 or 324_{X}, 324_{Y}, and 324_{Z}), typically digital micromirror devices, perform reflective color light modulation. In one implementation, light of three or more colors is modulated efficiently with only two modulators so that the component count and cost are low. In another implementation, each of three different colors is modulated with a separate modulator. A beam combiner (104 or 304) combines the digitally modulated beams (136* and 156* or 336_{X}*, 336_{Y}*, and 336_{Z}*) of color light to produce a composite beam (166 or 346) of the different colors. A projection lens device (106) projects the composite color beam.

### FIELD OF USE

This invention relates to color light projection and, in particular, to color light projection typically using digital light-processing (“DLP”) technology.

### BACKGROUND ART

A key component of a DLP color projector is a semiconductor chip, commonly referred to as a digital micromirror device (“DMD”), in which a microelectromechanical system is employed as a light modulation panel to achieve highly accurate color light modulation. The use of DMDs as light modulation panels enables DLP color projectors to have high resolution and high contrast. The image displayed by a DLP projector is normally bright and seamless.

Referring to FIG. 1, it illustrates a conventional three-panel (or three-chip) DLP lamp-source color projector as described in Hornbeck, “Digital Light Processing™ for High-Brightness, High-Resolution Applications”, 21st, The VXN Network, http://www.vxm.com, Summer 1998, 21pp. The DLP projector of FIG. 1 consists of lamp 20, curved light reflector 22, condenser lens 24, flat light reflector 26, five prisms 28, 30, 32, 34, and 36, blue-modulating DMD 38_{B}, green-modulating DMD 38_{G}, red-modulating DMD 38_{R}, and projection lens 40 arranged as shown. Prism 30 is separated from prism 28 by an air gap and from prism 32 by an air gap.

Lamp 20 provides unpolarized white light. Curved reflector 22 converts the white light from lamp 20 into beam 42 of white light. Condenser lens 24 relays white light beam 42 to flat reflector 26 which reflects beam 42 toward prism 28. White light beam 42 enters prism 28 and reflects off the front-most surface of prism 28 into prism 30.

The blue portion 42B of white light 42 reflects off the primary rear-most surface of prism 30, reflects off its front-most surface, and travels toward blue-modulating DMD 38_{B} along an incident axis at offset angle α_{B} to the main reflection axis of DMD 38_{B}. Blue light beam 42_{B} is digitally reflectively modulated by blue-modulating DMD 38_{B} to produce digitally modulated reflected blue light beam 44_{B} that travels along the DMD's main reflection axis. Modulated blue light beam 44_{B} enters prism 30, reflects off its front-most surface, reflects off its primary rear-most surface, and enters prism 28 traveling forward generally along the projector's main projection axis.

Remaining color portion 42_{C} of white light 42 enters prism 32. The red portion 42_{R} of color light 42_{C} reflects off the rear-most surface of prism 32 and travels toward travels toward red-modulating DMD 38_{R} along an incident axis at offset angle α_{R} to the main reflection axis of DMD 38_{R}. The green portion 42_{G} of color light 42_{C} enters prism 34 and travels toward travels toward green-modulating DMD 38_{G} along an incident axis at offset angle α_{G} to the main reflection axis of DMD 38_{G}. Red-modulating DMD 38_{B} and green-modulating DMD 38_{G} respectively reflectively digitally modulate red light beam 42_{R} and green light beam 42_{G} to produce digitally modulated reflected red light beam 44_{R} and green light beam 44_{G} that respectively travel along the main reflection axes of DMDs 38_{R} and 38_{G}. DMDs 38_{B}, 38_{R}, and 38_{G} generate modulated beams 44_{B}, 44_{R}, and 44_{G} by applying pulse-width modulation to incident beams 42_{B}, 42_{R}, and 42_{G} in response to an input electronic digital video signal.

Modulated red light beam 44_{R} enters prism 32, reflects off its front-most surface, reflects off its rear-most surface, and enters prism 28 traveling forward generally along the main projection axis. Modulated green light beam 44_{G} enters prism 34, passes through prisms 32 and 30, and enters prism 28 likewise traveling forward generally along the projector's main projection axis. Since modulated blue light beam 44_{B} is also traveling forward through prism 28 generally along the main projection axis, modulated color beams 44_{B}, 44_{R}, and 44_{G} are combined in prism 28 to produce composite modulated color light beam 46 that travels along the main projection axis. Modulated beam 46 passes through prism 36 and is projected by projection lens 40 onto a suitable surface (not shown) such as a screen.

Prisms 30 and 32 have suitable dichroic surfaces which enable the color splitting and color combining to occur in the preceding manner. The sizes, shapes, and constituencies of prisms 28, 30, 32, 34, and 36 are chosen so that they variously transmit and reflect light in the foregoing way. Prism 36 causes the optical path length to be largely the same across the area of composite modulated color beam 46.

The use of DMDs 38_{B}, 38_{R}, and 38_{G} enables the digital light modulation in the projector of FIG. 1 to be highly accurate. However, the characteristics of prisms 28, 30, 32, 34, and 36 have to be controlled very carefully. In addition, prisms 28, 30, 32, 34, and 36 occupy considerable space and cause the projector of FIG. 1 to be relatively bulky. The optical paths in the prism system are relatively long. As a result, the projector of FIG. 1 is also relatively expensive.

FIG. 2 illustrates a more recent conventional three-panel DLP lamp-source color projector, as disclosed in U.S. Pat. No. 7,144,116 B2, which addresses some of the deficiencies of the projector of FIG. 1. The projector of FIG. 2 consists of lamp 50, curved light reflector 52, light integrator 54, color splitter module 56, three total internal reflection (“TIR”) prism structures 58_{X}, 58_{Y}, and 58_{Z}, three respectively corresponding DMDs 60_{X}, 60_{Y}, and 60_{Z}, color combiner 62, and projection lens 64. Color splitter module 56 is formed with condenser lens 68, flat light reflector 70, condenser lens 72, two-way splitter mirror 74, condenser lens 76, flat light reflector 78, two-way splitter mirror 80, condenser lens 82, flat light reflector 84, condenser lens 86, and flat light reflector 88 arranged as shown in FIG. 2.

Lamp 50 furnishes unpolarized white light. Curved reflector 52 converts the white light from lamp 50 into beam 90 of white light. Light integrator 54 transforms white light 90 into light beam 92 of more uniform illumination intensity. Color splitter module 56 splits white light beam 92 into three color light beams 92_{X}, 92_{Y}, and 92_{Z} that respectively travel toward TIR prism structures 58_{X}, 58_{Y}, and 58_{Z}. Light beams 92_{X}, 92_{Y}, and 92_{Z} are of three different colors referred to here respectively as the first, second, and third colors.

TIR prism structures 58_{X}, 58_{Y}, and 58_{Z} cause color light beams 92_{X}, 92_{Y}, and 92_{Z} to be respectively directed toward DMDs 60_{X}, 60_{Y}, and 60_{Z} along respective incident axes at respective offset angles α_{X}, α_{Y}, and α_{Z} to the respective main DMD reflection axes. In response to an input electronic digital video signal, DMDs 60_{X}, 60_{Y}, and 60_{Z} respectively reflectively digitally pulse-width modulate color light beams 92_{X}, 92_{Y}, and 92_{Z} to produce digitally modulated reflected light beams 94_{X}, 94_{Y}, and 94_{Z} of the respective first, second, and third colors. Color combiner 62 combines modulated color light beams 94_{X}, 94_{Y}, and 94_{Z} to produce modulated color beam 96 which is projected by projection lens 64 onto a suitable surface (not shown) such as a screen.

Returning to color splitter 56, it operates in the manner indicated by the lines representing white light beam 92 and color light beams 92_{X}, 92_{Y}, and 92_{Z}. In brief, two-way splitter mirror 74 splits white beam 92 into reflected light beam 92_{Y} of the second color and transmitted light beam 92_{W} of the complement of the second selected color. Two-way splitter mirror splits light beam 92_{W} of the complement of the second selected color into light beam 92_{X} of the first color and light beam 92_{Z} of the third color.

Color splitter 56 in the projector of FIG. 2 avoids the use of prisms and the color-splitting difficulties arising with prisms. TIR prism structures 58_{X}, 58_{Y}, and 58_{X} are only used for directing light in the projector of FIG. 2. The optical paths of prism structures 58_{X}, 58_{Y}, and 58_{X} are comparatively short compared to the optical paths in the prism system of the earlier projector of FIG. 1. As a result, the projector of FIG. 2 is likely to perform better than the projector of FIG. 1 and to be less expensive. However, the three-panel DLP color projectors of FIGS. 1 and 2 both utilize color splitting and therefore require structure for performing the color splitting.

It would be desirable to have a DLP color projector which avoids color splitting. In addition, it would be desirable to take advantage of advances in light-source technology, especially in light-emitting diodes.

### GENERAL DISCLOSURE OF THE INVENTION

The present invention furnishes color projectors which typically employ digital micromirror devices (again “DMDs”) for digital color light modulation while avoiding color splitting. Instead, light-emitting diodes (“LEDs”) are used to provide light of multiple colors in the projectors of the invention. As a result, the number of components is reduced compared to the conventional projector of FIG. 1 or 2. Also, the average optical path length is typically reduced due to the avoidance of structure for splitting white light into its components. Consequently, the projectors of the invention operate more efficiently than that of FIG. 1 or 2.

More particularly, a light projector for projecting an image of color light in response to an electronic digital video signal contains, in accordance with the invention, a first optical assembly, a second optical assembly, a beam combiner, and a projection lens device. The first optical assembly processes light of a first selected color. The second optical assembly processes light of a plural number of second selected colors different from one another and from the first selected color. In total, the two optical assemblies process light of at least three different colors.

The use of only two optical assemblies for processing light of three or more different colors results in a relatively low component count and an efficient projector design. In the typical case where the number of colors of light processed by the second optical assembly is two, the two optical assemblies together process light of three different colors, normally green, red, and blue.

The components of the first optical assembly include a first LED, first light-converting structure, and a first modulating device. The first light-emitting diode emits light of the first selected color to produce a first intermediate beam of light of the first selected color. The first light-converting structure converts the first intermediate beam of the first selected color into a second intermediate beam of light of the first selected color. In response to the digital video signal, the first modulating device reflectively modulates the second intermediate beam of the first selected color as that beam travels generally along a first incident axis to produce a digitally modulated further beam of light of the first selected color traveling generally along a first reflection axis.

The components of the second optical assembly include a plural number of second LEDs, one for each different color of light processed by that optical assembly. Each second LED emits light of a different one of the second selected colors to produce a first intermediate beam of light of that second selected color. Consequently, there are a like plural number of first intermediate beams of light of the second selected colors.

The components of the second optical assembly further include second light-converting structure and a second modulating device. The second light-converting structure converts the first intermediate beams of the second selected colors respectively into a like plural number of second intermediate beams of light of the second selected colors. Responsive to the digital video signal, the second modulating device reflectively modulates the second intermediate beams of the second selected colors as those beams travel generally along a second incident axis to respectively produce a like plural number of digitally modulated further beams of light of the second selected colors traveling generally along a second reflection axis.

The beam combiner combines light of the further beams to produce a composite digitally modulated beam of light of the selected colors. The projection lens device then projects light of the composite beam.

The first reflection axis is normally at a first non-zero offset angle to the first incident axis. The second reflection axis is likewise normally at a second non-zero offset angle to the second incident axis. In that case, each modulating device is normally implemented with a DMD. Inasmuch as the second modulating device modulates light of two or more colors, the projector normally includes a control device for causing each second light-emitting diode to switch between light-emissive and non-light-emissive states at a selected duty cycle.

The projector normally needs to produce white light. In the typical situation where the two optical assemblies process green, red, and blue light, white light is produced by appropriately combining these three colors of light. Green light constitutes the large majority of white light in that combination. As a result, green light needs the most modulation for achieving high luminous intensity among green, red, and blue light.

In view of the foregoing modulation requirement, green light is preferably processed by the first optical assembly, i.e., the optical assembly which processes light of only one color. This enables green light to be modulated by the modulating device which modulates light of only one color. The second optical assembly then processes red and blue light. By performing the light modulation in this manner, the projector normally avoids allocating light modulation capability for time periods during which no modulation is performed. The projector thereby operates very efficiently with a reduced component count so as to reduce the projector cost.

The invention provides another light projector for projecting an image of color light in response to an electronic digital video signal. This second inventive light projector contains a plurality of optical assemblies, a beam combiner, and a projection lens. Each optical assembly in the second inventive projector processes light of a different selected color. Although this normally causes the second inventive projector to have a slightly higher component count than the first inventive light projector, the second inventive projector still has fewer components that the conventional projector of FIG. 1 or 2. In addition, the second inventive projector is capable of processing each color of light highly efficiently because the characteristics of each optical assembly can be tailored to the color of light processed by that optical assembly.

The components of each optical assembly in the second inventive light projector include an LED, light-converting structure, and a modulating device. The LED emits light of a different one of the selected colors to produce a first intermediate beam of light of that selected color. The light-converting structure converts the first intermediate beam into a second intermediate beam of light of the selected color. In response to the digital video signal, the modulating device reflectively modulates the second intermediate beam as it travels generally along an incident axis to produce a digitally modulated further beam of light of the selected color traveling generally along a reflection axis at a non-zero offset angle to the incident axis. Each modulating device is normally implemented with a DMD.

The beam combiner in the second inventive light projector combines light of the further beams to produce a composite digitally modulated beam of light of the selected colors. The projection lens device projects light of the composite beam.

In short, the use of LEDs as light sources in the projectors of the invention enables a projector designer to take advantage of high-brightness LEDs that are now commercially available. The invention also normally takes advantage of the highly accurate digital color modulation provided by DMDs. The average optical path length in the inventive projectors is likewise typically comparatively low, thereby leading to highly efficient operation. The component count in the inventive projectors is comparatively low. Also, the projectors are of comparatively small size.

All light modulation in the inventive projectors is performed before any light beams are combined. Consequently, the optical path of each fully modulated light beam can be modified to meet application needs largely independent of the optical path of each other fully modulated light beam. Development cost and time are greatly reduced. Color splitting and the attendant difficulties with color spitting are avoided in the projectors of the invention. The projector size is reduced so as to reduce the sales price. The projector performance is highly efficient. The invention thus provides a substantial advance over the prior art.

### BRIEF DESCRIPTION OF THE DRAWINGS

FIGS. 1 and 2 are diagrams of conventional three-panel DLP lamp-source color light projectors.

FIG. 3 is a diagram of a two-panel DLP LED-source color light projector configured according to the invention.

FIG. 4 is a diagram of an embodiment of the two-panel LED-source color light projector of FIG. 3.

FIG. 5 is a diagram of a three-panel DLP LED-source color light projector configured according to the invention.

FIG. 6 is a diagram of an embodiment of the three-panel LED-source color light projector of FIG. 5.

FIGS. 7a and 7b are perspective views of two respective embodiments of each light integrator in the LED-source color light projector of FIG. 4 or 6.

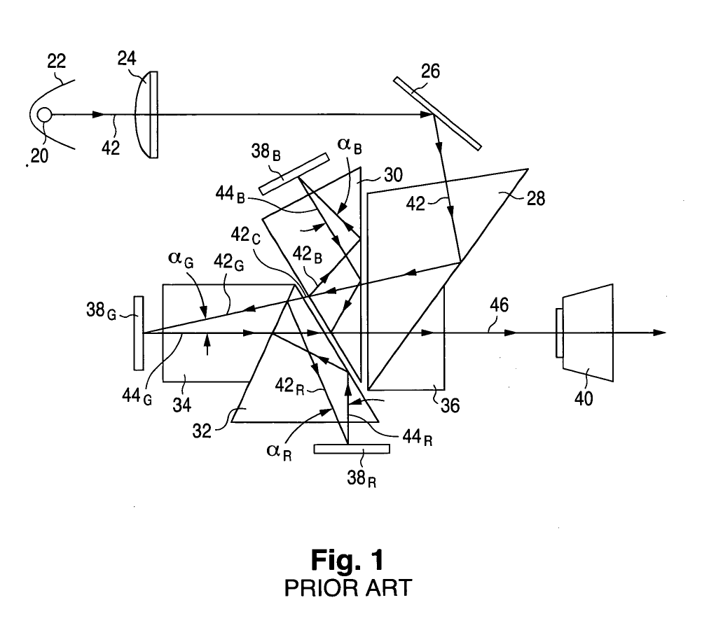

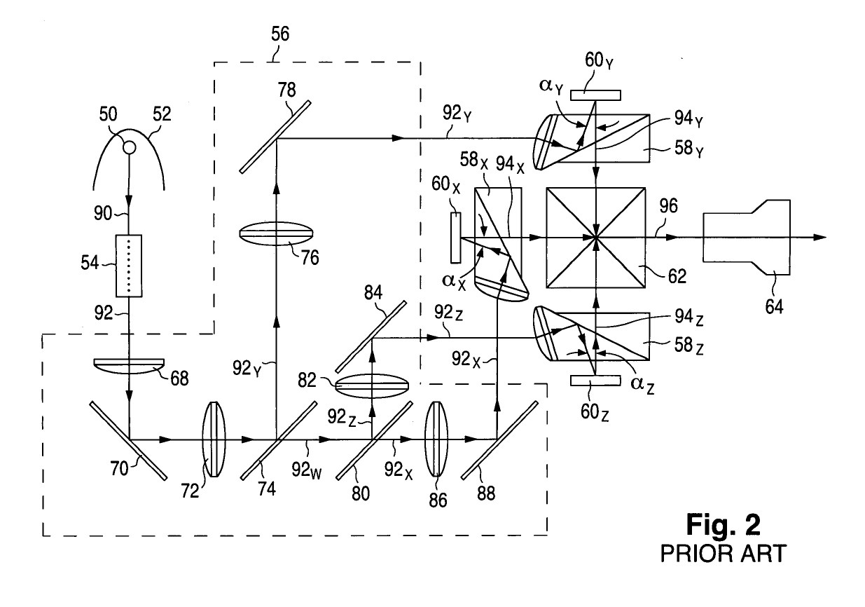

Like reference symbols are used in the drawings and in the description of the preferred embodiments to represent the same, or very similar, item or items.

In situations where a beam of light is described below as traveling (or propagating) along an axis, both the axis and the beam of light are represented by the same line (or arrow) in the drawings. Different reference symbols are used for the axis and the beam of light.

The small changes in light ray direction that occur in situations where a light ray travels from one medium to another medium of a different index of refraction than the first medium are, for simplicity in illustration, not shown in the drawings because such directional changes are not particularly material to the present invention.

### DESCRIPTION OF THE PREFERRED EMBODIMENTS

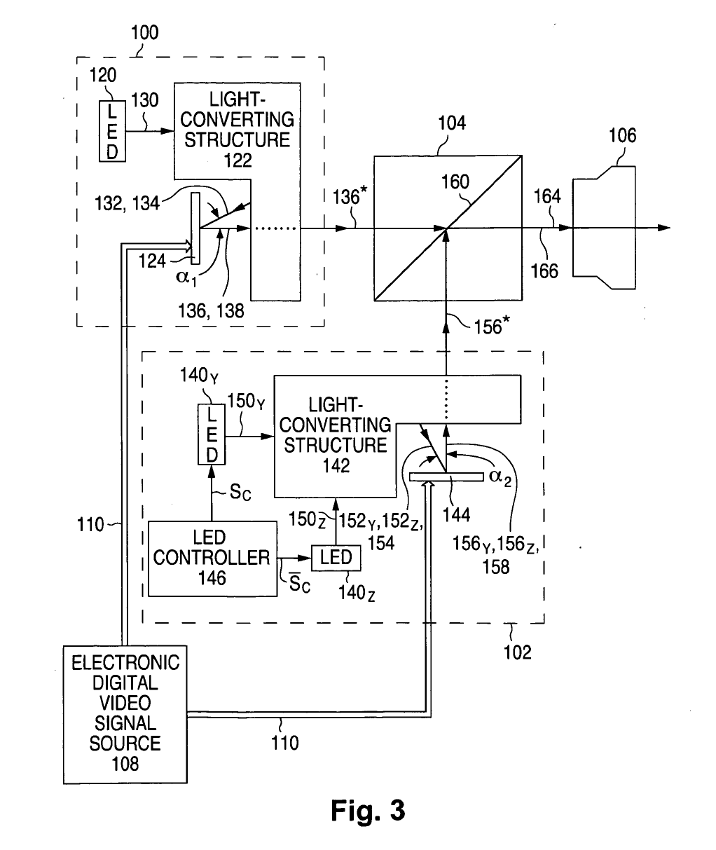

FIG. 3 illustrates a general two-panel DLP LED-source color light projector configured according to the invention. The two-panel projector of FIG. 3 consists of a one-LED first optical assembly 100, a two-LED second optical assembly 102, a beam combiner 104, a projection lens device 106, and an electronic digital video signal source 108 that provides an input electronic digital video signal 110 at a video update frequency f_{FR}.

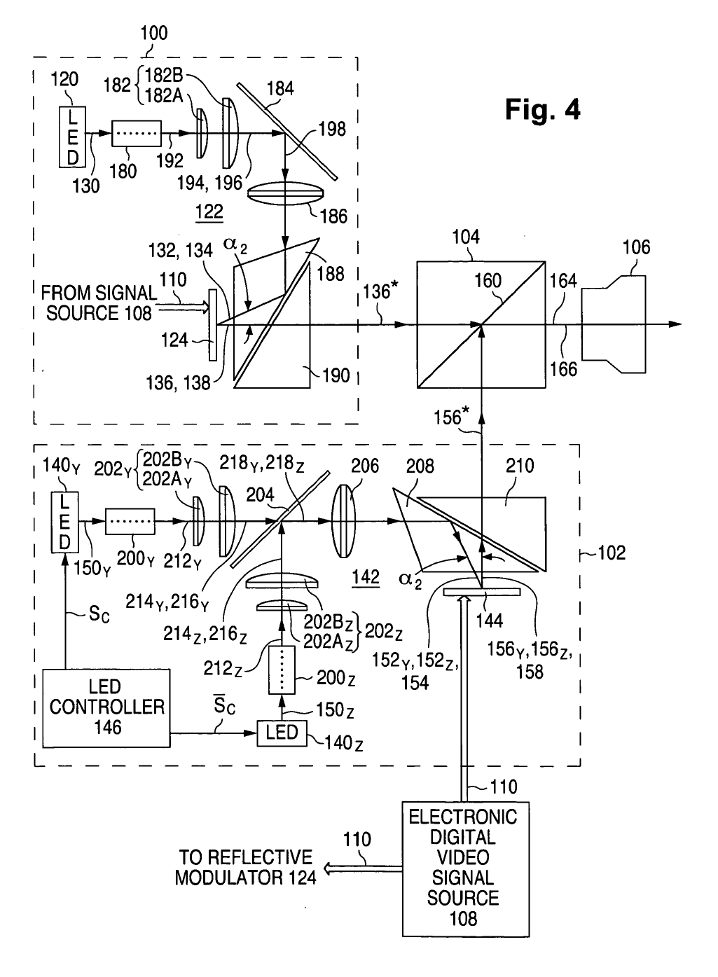

First optical assembly 100 is formed with a first color LED 120, first light-converting structure 122, and a first offset-angle reflective digital light modulating device 124. LED 120 emits light of a first selected color, referred to here as first selected color X, to produce a first intermediate beam 130 of light of first selected color X. Light-converting structure 122 converts first intermediate color beam 130 into a second intermediate beam 132 of light of first selected color X. As described below in connection with FIG. 4, the light-conversion function of light-converting structure 122 typically involves integrating and collimating light of first intermediate color beam 130 and appropriately changing the light propagation direction in producing second intermediate color beam 132.

Second intermediate beam 132 of color X impinges on offset-angle reflective digital light modulating device 124 along a first incident axis 134. In response to electronic digital video signal 110 provided by digital video signal source 108, modulating device 124 digitally reflectively modulates incident second intermediate color beam 132 according to pulse-width modulation to produce a digitally modulated further beam 136 of light of color X. Modulated further color beam 136 is formed with selected reflected light of second intermediate color beam 132. Immediately after being produced, modulated further color beam 136 travels along a first modulator reflection axis 138 at a first non-zero reflection offset angle α₁ to first incident axis 134.

First optical assembly 100 provides light of modulated further color beam 136 as a digitally modulated assembly output beam 136* of color X. In producing modulated assembly output color beam 136* from modulated further color beam 136, light of further color beam 136 typically passes through light-converting structure 122. Accordingly, modulated assembly output color beam 136* may differ slightly from modulated further color beam 136. However, the light modulation provided by reflective light modulating device 122 is not significantly changed. Assembly output beam 136* of color X is modulated substantially the same as further beam 136 of color X.

Second optical assembly 102 is formed with a pair of second color LEDs 140_{Y} and 140_{Z}, second light-converting structure 142, a second offset-angle reflective digital light modulating device 144, and an LED controller 146 that provides a pair of largely complementary LED switching signals S_{C} and S̅_{C}. Responsive respectively to switching signals S_{C} and S̅_{C}, LEDs 140_{Y} and 140_{Z} emit light of a pair of respective second selected colors, referred to here respectively as second selected colors Y and Z, to respectively produce a pair of first intermediate beams 150_{Y} and 150_{Z} of light of second selected colors Y and Z. Second selected colors Y and Z of light provided respectively by LEDs 140_{Y} and 140_{Z} in second optical assembly 102 are different from each other and from first selected color X of light provided by LED 120 in first optical assembly 100.

Each switching signal S_{C} or S̅_{C} causes LED 140_{Y} or 140_{Z} in second optical assembly 102 to switch between light-emissive and non-light-emissive states at a selected duty cycle. Since switching signal S̅_{C} is largely complementary to switching signal S_{C}, the duty cycle of switching signal S̅_{C} is largely complementary to the duty cycle of switching signal S_{C}. LED controller 146 thereby causes LED 140_{Z} to be turned on and emit light of color Z substantially when LED 140_{Y} is turned off and not emitting light of color Y, and vice versa.

Light-converting structure 142 in second optical assembly 102 converts first intermediate color beams 150_{Y} and 150_{Z} respectively into a pair of second intermediate beams 152_{Y} and 152_{Z} of light of second selected colors Y and Z. As described below in connection with FIG. 4, the light-conversion function of light-converting structure 142 typically involves integrating and collimating light of first intermediate color beam beams 150_{Y} and 150_{Z} and appropriately changing their light propagation direction in producing second intermediate color beams 152_{Y} and 152_{Z}.

Second intermediate beam 152_{Y} of color Y impinges on offset-angle reflective digital light modulating device 144 along a second incident axis 154. Second intermediate beam 152_{Z} of color Z likewise impinges on modulating device 144 along second incident axis 154. Because LED 140_{Z} is turned on when LED 140_{Y} is turned off and vice versa, second intermediate beam 152_{Z} of color Z impinges on modulating device 144 when second intermediate beam 152_{Y} of color Y is not impinging on modulating device 144, and vice versa. Second intermediate color beams 152_{Y} and 152_{Z} occupy largely the same volume of space in the projector of FIG. 3.

Responsive to electronic digital video signal 110 provided by digital video signal source 108, modulating device 144 digitally reflectively modulates incident second intermediate color beam 152_{Y} according to pulse-width modulation to produce a digitally modulated further beam 156_{Y} of light of color Y. In response to video signal 110, modulating device 144 likewise digitally reflectively modulates incident second intermediate color beam 152_{Z} according to pulse-width modulation to produce a digitally modulated further beam 156_{Z} of light of color Z. Video signal 110 switches between modulating second intermediate color beams 152_{Y} and 152_{Z} generally in accordance with the duty cycles of switching signals S_{C} and S̅_{C} furnished by LED controller 146.

Modulated further color beam 156_{Y} is formed with selected reflected light of second intermediate color beam 152_{Y}. Modulated further color beam 156_{Z} is similarly formed with selected reflected light of second intermediate color beam 152_{Z}. Immediately after being timewise separately produced, modulated further color beams 156_{Y} and 156_{Z} travel along a second modulator reflection axis 158 at a second non-zero reflection offset angle α₂ to second incident axis 154. Modulated further color beams 156_{Y} and 156_{Z} occupy largely the same volume of projector space. As a result, further color beams 156_{Y} and 156_{Z} are effectively combined into a modulated further color beam of light of colors Y and Z.

Second optical assembly 102 provides light of modulated further color beams 156_{Y} and 156_{Z} as a digitally modulated assembly output beam 156* of colors Y and Z. In producing modulated assembly output color beam 156* from modulated further color beams 156_{Y} and 156_{Z}, light of further color beams 156_{Y} and 156_{Z} typically passes through light-converting structure 142. Accordingly, modulated assembly output color beam 156* may differ slightly from the combination of modulated further color beams 156_{Y} and 156_{Z}. However, the light modulation provided by reflective light modulating device 144 is not significantly changed. Assembly output beam 156* of colors Y and Z is modulated substantially the same as the combination of further beams 156_{Y} and 156_{Z} of colors Y and Z.

Second light-converting structure 142 is preferably configured so that the optical path length of the light of further beam 156_{Z} of color Z is approximately the same as the optical path length of the light of further beam 156_{Y} of color Y. As a result, the Y and Z light portions of assembly output beam 156* are of approximately the same optical path length. In addition, first optical assembly 122 is preferably configured so that the light of assembly output beam 136* of color X is of approximately the same optical path length as the light of assembly output beam 156* of colors Y and Z.

Beam combiner 104 has a dichroic plate (or mirror) 160 situated at approximately a 45° angle to the main projection optical axis 164 of the projector of FIG. 3. Dichroic plate 160 is constructed so as to largely transmit incident light of the wavelength of color X and to largely reflect incident light of the wavelengths of colors Y and Z. The projector of FIG. 3 is arranged so that output beam 136* of color X provided by first optical assembly 100 impinges on the rear surface of dichroic plate 160 traveling substantially forward along main projection axis 164. Light of assembly output beam 136* is thereby largely transmitted through dichroic plate 160 without significant change of direction.

The projector of FIG. 3 is further arranged so that output beam 156* of colors Y and Z provided by second optical assembly 102 impinges on the front surface of dichroic plate 160 traveling substantially perpendicular to main projection axis 164. With dichroic plate 160 being at approximately 45° angle to main projection axis 164, light of assembly output beam 156* is reflected by approximately 90° so as to travel forward along main projection axis 164. Light of both of assembly output beams 136* and 156* is therefore combined by beam combiner 104 to form a composite digitally modulated projector output beam 166 of light of colors X, Y, and Z.

As mentioned above, light of modulated further color beam 136_{X} forms modulated assembly output beam 136* of color X while light of modulated further color beams 156_{Y} and 156_{Z} forms digitally modulated assembly output beam 156* of colors Y and Z. Consequently, beam combiner 104 produces composite modulated light beam 166 of colors X, Y, and Z by combining light of modulated further color beams 136, 156_{Y}, and 156_{Z}. Projection lens device 106 projects composite projector output color beam 166 onto a suitable imaging surface (not shown) such as a screen to produce an image, typically time varying, on the imaging surface.

Composite projector output color beam 166 is updated at update frequency f_{FR} of input electronic digital signal 110. Frequency f_{FR} is the frequency at which frames of the video image are generated. The period T_{FR} of time between consecutive updates, i.e., the frame period, equals 1/f_{FR}. Each frame update period T_{FR} essentially consists of a frame off interval T_{FROFF} and a frame on interval T_{FRON}. Updating occurs during frame off intervals T_{FROFF}. Composite color beam 166 provides its image generally during frame on intervals T_{FRON}.

More particularly, each offset-angle digital light modulating device 124, 144_{Y}, or 144_{Z} operates at a modulation frequency f_{MOD} which is at least as great, typically considerably greater than, frame update frequency f_{FR}. The operation of digital modulation devices 124, 144_{Y}, and 144_{Z} is suitably frequency synchronized to the operation of digital video signal source 108 and to the operation of LED controller 146 in second optical assembly 102. Composite color beam 166 is actively provided during each frame on interval T_{FRON} subject to the modulation provided by digital modulation devices 124, 144_{Y}, and 144_{Z}.

Consider an example in which modulation frequency f_{MOD} equals frame update frequency f_{FR}. In that case, the X portion of color beam 166 is provided during all of each frame on interval T_{FRON}. The Y portion of composite color beam 166 is then provided during part of each frame on interval T_{FRON} depending on the duty cycle of switching signal S_{C}. The Z portion of color beam 166 is provided during most of the remainder of each frame on interval T_{FRON} depending on the complementary duty cycle of switching signal S̅_{C}. Update frequency f_{FR} is normally sufficiently great, typically 60 or 120 Hz, that the human eye normally cannot discern that each of the Y and Z portions of color beam 166 is not provided during all of each frame on interval T_{FRON}.

In the typical situation where modulation frequency f_{MOD} is considerably greater than frame update frequency f_{FR}, each frame on interval T_{FRON} consists of a group of modulation subperiods T_{MOD}. Each modulation subperiod T_{MOD} essentially consists of a modulation off interval T_{MODOFF} and a modulation on interval T_{MODON}. Modulation occurs during modulation off intervals T_{MODOFF}. The X portion of composite color beam 166 is then provided during the modulation on periods T_{MOD} of each frame on interval T_{FRON}. The Y portion of color beam 166 is provided during the modulation on periods T_{MOD} of part of each frame on interval T_{FRON} depending on the duty cycle of switching signal S_{C}. The Z portion of color beam 166 is provided during the modulation on periods T_{MOD} of most of the remainder of each frame on interval T_{FRON} depending on the complementary duty cycle of switching signal S̅_{C}. The result is basically the same as in the situation where modulation frequency f_{MOD} equals frame update frequency f_{FR} except that the X, Y, and Z portions of composite color beam 166 each switch on and off multiple times during each frame on interval T_{FRON}.

In a typical situation, one of colors X, Y, and Z is red, another of colors X, Y, and Z, and the last of colors X, Y, and Z is blue. That is, first optical assembly 100 typically processes a selected one of red, green, and blue light to generate modulated further beam 136 as that selected one of red, green, and blue light. Second optical assembly 102 then processes the remaining two of red, green, and blue light to generate modulated further beams 156_{Y} and 156_{Z} as those remaining two of red, green, and blue light.

The projector of FIG. 3 also produces white light as an appropriate combination of colors X, Y, and Z. When generated from red, green, and blue light, white light consists of approximately 70% green light, approximately 25% red light, and approximately 5% blue light. Green light thus constitutes the large majority of white light formed from red, green, and blue light. Accordingly, the need for modulation of color light to enhance luminous intensity among these three colors is typically greatest for green light, second greatest for red light, and least for blue light. In the typical situation where colors X, Y, and Z consist of red, green, and blue, color X for first optical assembly 100 which processes light of only one color is therefore selected as green because this enables all of the modulation capability of optical assembly 100 to be expended in modulating the color light needing the most modulation. Colors Y and Z for the colors of light processed by second optical assembly 102 are then respectively selected as red and blue or blue and red.

Allocating green, red, and blue among optical assemblies 100 and 102 in the foregoing manner avoids the allocation of light modulation capability for modulation periods when no modulation is needed. Consequently, the light projector of FIG. 3 operates highly efficiently with a low component count.

The green light processed by first optical assembly 100 to produce modulated further beam 136 has a wavelength of 500-580 nm, preferably 505-570 nm, more preferably 510-560 nm. The red light processed by second optical assembly 102 to produce one of modulated further beams 156_{Y} and 156_{Z} has a wavelength of 600-720 nm, preferably 610-700 nm, more preferably 620-680 nm. The blue light processed by second optical assembly 102 to produce the other of modulated further beams 156_{Y} and 156_{Z} has a wavelength of 400-495 nm, preferably 430-490 nm, more preferably 445-485 nm.

FIG. 4 illustrates an implementation of the general two-panel LED-source color light projector of FIG. 3. Implementations of light-converting structures 122 and 142 are specifically shown in FIG. 4. First light-converting structure 122 here consists of a first light integrator 180, a first light collimator 182, a folding mirror (light reflector) 184, a first condenser (relay) lens 186, and a first prism structure formed with a first input prism 188 and a first output prism 190. Prisms 188 and 190 are separated from each other by a small space.

The illumination intensity of first intermediate light beam 130 of color X provided by first color LED 120 is normally significantly non-uniform across the area of color beam 130. First light integrator 180 integrates light of color beam 130 to produce an integrated beam 192 of light of color X of more uniform areal illumination intensity than that of color beam 130. Rays of integrated color beam 192 propagate in various individual directions generally toward first light collimator 182.

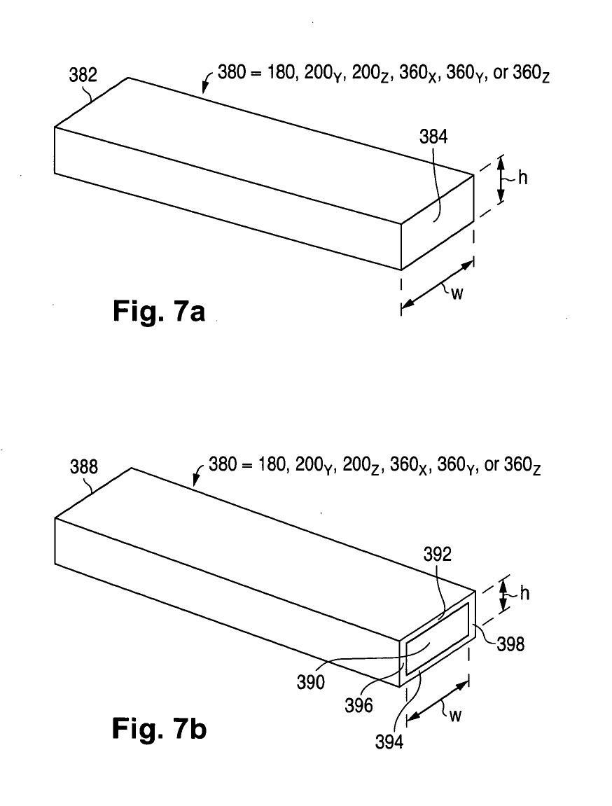

The integration process in first light integrator 180 entails mixing rays of first intermediate color beam 130. Exemplary embodiments of light integrator 180 are described below in connection with FIG. 7. Because integrated color beam 192 is of more uniform areal illumination intensity than first intermediate color beam 130, second intermediate light beam 132 of color X is of more uniform areal illumination intensity than color beam 130.

First light collimator 182 collimates light of integrated color beam 192 to produce a collimated light beam 194 of color X traveling along a collimation axis 196. Light collimator 182 consists of a first input plano-convex collimating lens 182A and a first output plano-convex collimating lens 182B. Integrated color beam 192 impinges on the planar side of first input collimating lens 182A. The planar side of first output collimating lens 182B is situated opposite the convex side of input collimating lens 182A. Light of integrated color beam 192 passes through collimating lenses 182A and 182B and emerges from the convex side of output collimating lens 182B as collimated color beam 194 propagating along collimation axis 196.

Folding mirror 184 reflects light of collimated color beam 194 by approximately 90° to produce a reflected light beam 198 of color X. First condenser lens 186, a double-convex lens, relays reflected color beam 198 to the first prism structure formed with first input prism 188 and first output prism 190.

Input prism 188 is an oblique triangular total internal reflection (again “TIR”) prism having an input short side, a rear-most short side, and a long side. Prism 188 is arranged so that collimated light of reflected color beam 198 enters the prism's input short side and reflects off the internal surface of the prism's long side to produce second intermediate light beam 132 of color X traveling along first incident axis 134 toward first offset-angle light modulating device 124. In particular, collimated light of reflected color beam 198 impinges on the internal surface of the long side of prism 188 at an incident angle which, as measured relative to a normal to that prism surface, is greater than the critical internal reflection angle of prism 188. Substantially all of the light of reflected color beam 198 impinging on the internal surface of the prism's long side is then reflected off that prism surface and passes through the rear-most short side of prism 188 to form second intermediate color beam 132 propagating toward light modulator 124.

After first offset-angle light modulating device 124 performs its light modulation operation to produce further light beam 136 of color X traveling along modulator reflection axis 138, further color beam 136 enters first input prism 188 along its rear-most short side and impinges on the internal surface of its long side at an incident angle which, again as measured relative to a normal to that prism surface, is less than the critical internal reflection angle of prism 188. As a result, a large portion of the light of further color beam 136 passes through the internal surface of the prism's long side and enters the space between input prism 188 and output prism 190.

Output prism 190 is a right triangular prism having a rear-most long (diagonal) side, a front-most short side, and another short side. The foregoing portion of the light of further color beam 136 subsequently enters output prism 190 along its rear-most long side and passes through prism 190 to produce assembly output light beam 136* of color X. Assembly output color beam 136* exits output prism 190 along its front-most short side propagating substantially perpendicular to the prism's front-most short side.

Achievement of the preceding light-reflection/light-transmission actions in input prism 188 entails configuring it so that the optical path length of further color beam 136 varies somewhat across its beam area. Output prism 190 compensates for this optical path length so that the optical path length of the light of assembly output color beam 136* is substantially the same across its beam area.

Second light-converting structure 142 in FIG. 4 consists of a pair of second light integrators 200Y and 200Z, a pair of second light collimators 202Y and 202Z, a dichroic plate 204, a second condenser (relay) lens 206, and a second prism structure formed with a second input prism 208 and a second output prism 210. Similar to prisms 188 and 190 in the prism structure of first light-converting structure 122, prisms 188 and 190 in the prism structure of second light-converting structure 142 are separated from each other by a small space.

The illumination intensity of first intermediate light beam 150_{Y} or 150_{Z} of color Y or Z provided by second color LED 140_{Y} or 140_{Z} is normally significantly non-uniform across the area of color beam 150_{Y} or 150_{Z}. Second light integrator 200_{Y} or 200_{Z} integrates light of color beam 150_{Y} or 150_{Z} to produce an integrated beam 212_{Y} or 212_{Z} of light of color Y or Z of more uniform areal illumination intensity than that of color beam 150_{Y} or 150_{Z}. Rays of integrated color beam 212_{Y} or 212_{Z} propagate in various individual directions generally toward second light collimator 202_{Y} or 202_{Z}.

The integration process in second light integrator 200_{Y} or 200_{Z} entails mixing rays of first intermediate color beam 150_{Y} or 150_{Z}. As with first light integrator 180, exemplary embodiments of second light integrator 210_{Y} or 210_{Z} are described below in connection with FIG. 7. Because integrated color beam 212_{Y} or 212_{Z} is of more uniform areal illumination intensity than first intermediate color beam 150_{Y} or 150_{Z}, second intermediate light beam 152_{Y} or 152_{Z} of color Y or Z is of more uniform areal illumination intensity than color beam 150_{Y} or 150_{Z}.

Second light collimator 202_{Y} or 202_{Z} collimates light of integrated color beam 212_{Y} or 212_{Z} to produce a collimated light beam 214_{Y} or 214_{Z} of color Y or Z traveling along a collimation axis 216_{Y} or 216_{Z}. Light collimator 202_{Y} or 202_{Z} consists of a first input plano-convex collimating lens 202A_{Y} or 202A_{Z} and a first output plano-convex collimating lens 202B_{Y} or 202B_{Z}. Integrated color beam 212_{Y} or 212_{Z} impinges on the planar side of first input collimating lens 202A_{Y} or 202A_{Z}. The planar side of first output collimating lens 202B_{Y} or 202B_{Z} is situated opposite the convex side of input collimating lens 202A_{Y} or 202A_{Z}. Light of integrated color beam 212_{Y} or 212_{Z} passes through collimating lenses 202A_{Y} and 202B_{Y} or 202A_{Z} and 202B_{Z} and emerges from the convex side of output collimating lens 202B_{Y} or 202B_{Z} as collimated color beam 214_{Y} or 214_{Z} propagating along collimation axis 216_{Y} or 216_{Z}.

Dichroic plate 204 transmits light of collimated color beam 204_{Y} to produce a transmitted light beam 218_{Y} of color Y. Dichroic plate 204 also reflects light of collimated color beam 204_{Z} by approximately 90° to produce a reflected light beam 218_{Z} of color Z. Transmitted color beam 218_{Y} and reflected color beam 218_{Z} occupy largely the same volume of projector space. Second condenser lens 206, a double-convex lens, relays transmitted color beam 218_{Y} and reflected color beam 218_{Z} to the second prism structure formed with second input prism 208 and second output prism 210.

Input prism 208 is an oblique triangular TIR prism having an input short side, a rear-most short side, and a long side. Prism 208 is arranged so that collimated light of transmitted color beam 218_{Y} enters the prism's input short side and reflects off the internal surface of the prism's long side to produce second intermediate light beam 152_{Y} of color Y traveling along first incident axis 154 toward second offset-angle light modulating device 144. Collimated light of reflected color beam 218_{X} similarly enters the prism's input short side and reflects off the internal surface of the prism's long side to produce second intermediate light beam 152_{Z} of color Z traveling along first incident axis 154 toward second offset-angle light modulator 144.

In particular, collimated light of each of transmitted color beam 218_{Y} and reflected color beam 218_{Z} impinges on the internal surface of the long side of input prism 218 at an incident angle which, as measured relative to a normal to that prism surface, is greater than the critical internal reflection angle of prism 218. Substantially all of the collimated light of transmitted color beam 218_{Y} or reflected color beam 218_{Z} impinging on the internal surface of the prism's long side is then reflected off that prism surface and passes through the rear-most short side of prism 218 to form second intermediate color beam 152_{Y} or 152_{Z} propagating toward light modulating device 144.

After second offset-angle light modulating device 144 performs its light modulation operation to produce further light beam 156_{Y} or 156_{Z} of color Y or Z traveling along modulator reflection axis 158, further color beam 156_{Y} or 156_{Z} enters second input prism 208 along its rear-most short side and impinges on the internal surface of its long side at an incident angle which, again as measured relative to a normal to that prism surface, is less than the critical internal reflection angle of prism 218. Consequently, a large portion of the light of further color beam 156_{Y} or 156_{Z} passes through the internal surface of the prism's long side and enters the space between input prism 208 and output prism 210.

Output prism 210 is a right triangular prism having a rear-most long (diagonal) side, a front-most short side, and another short side. The foregoing portions of the light of further color beams 156_{Y} and 156_{Z} subsequently enter output prism 210 along its rear-most long side and pass through prism 210 to produce assembly output light beam 156* of colors Y and Z. Assembly output color beam 156* exits output prism 210 along its front-most short side propagating substantially perpendicular to the prism's front-most short side.

Achievement of the preceding light-reflection/light-transmission actions in input prism 208 entails configuring it so that the optical path length of further color beam 156_{Y} or 156_{Z} varies somewhat across its beam area. Similar to what occurs in output prism 190 of first prism structure 188/190, output prism 210 in second prism structure 208/210 compensates for this optical path length so that the optical path length of the light of assembly output color beam 156* is substantially the same across its beam area.

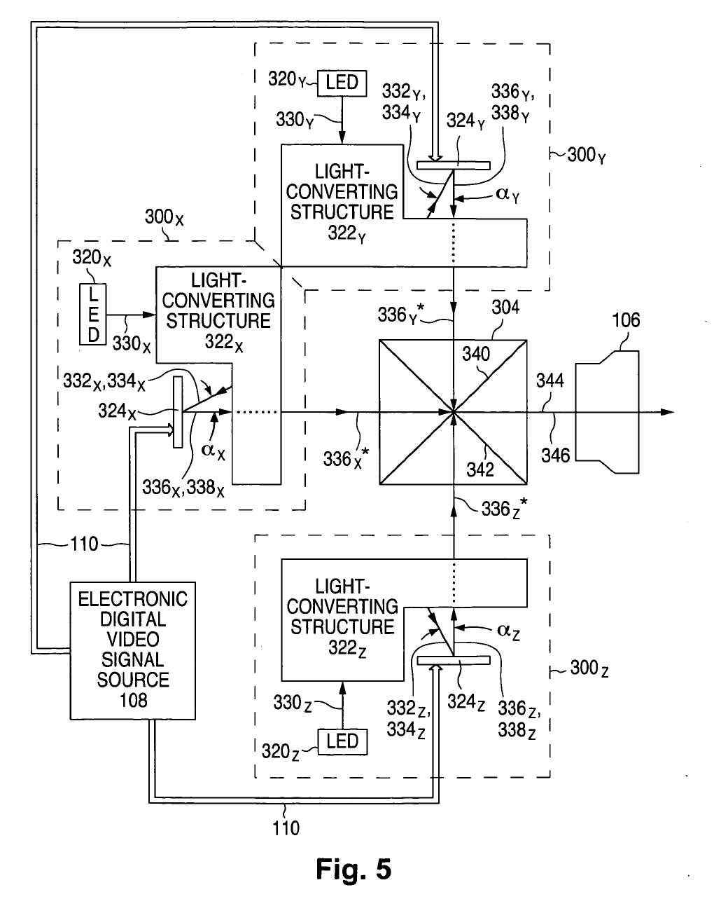

FIG. 5 illustrates a general three-panel DLP LED-source color light projector configured according to the invention. The three-panel projector of FIG. 5 consists of three one-LED optical assemblies 300_{X}, 300_{Y}, and 300_{Z}, an X-cube beam combiner 304, projection lens device 106, and electronic digital video signal source 108 that provides input electronic digital video signal 110 at video update frequency f_{FR}.

Letting W be a letter varying from X to Z, each optical assembly 300_{W} is formed with a color LED 320_{W}, light-converting structure 322_{W}, and an offset-angle reflective digital light modulating device 324_{W}. Each LED 320_{W} emits light of a different one of three selected colors, referred to here as selected colors X, Y, and Z, to produce a first intermediate beam 330_{W} of light of selected color W. Each light-converting structure 322_{W} converts first intermediate color beam 330_{W} into a second intermediate beam 332_{W} of light of selected color W.

Second intermediate beam 332_{W} of color W impinges on offset-angle reflective digital light modulating device 324_{W} along an incident axis 334_{W}. Responsive to electronic digital video signal 110 provided by digital video signal source 108, modulating device 324_{W} digitally reflectively modulates incident second intermediate color beam 332_{W} according to pulse-width modulation to produce a digitally modulated further beam 336_{W} of light of color W. Modulated further color beam 336_{W} is formed with selected reflected light of second intermediate color beam 332_{W}. Immediately after being produced, modulated further color beam 336_{W} travels along a modulator reflection axis 338_{W} at a first non-zero reflection offset angle α_{W} to incident axis 334_{W}.

Each optical assembly 300_{W} provides light of modulated further color beam 336_{W} as a digitally modulated assembly output beam 336_{W}* of color W. In producing modulated assembly output color beam 336_{W}* from modulated further color beam 336_{W}, light of further color beam 336_{W} typically passes through light-converting structure 322_{W}. Accordingly, modulated assembly output color beam 336_{W}* may differ slightly from modulated further color beam 336_{W}. However, the light modulation provided by reflective light modulating device 322_{W} is not significantly changed. Assembly output beam 336_{W}* of color W is modulated substantially the same as further beam 336_{W} of color W. Light-converting structures 322_{X}, 322_{Y}, and 322_{Z} are preferably configured so that the light of each assembly output beam 336_{W}* is of approximately the same optical path length as the light of each other assembly output light beam 336_{W}*.

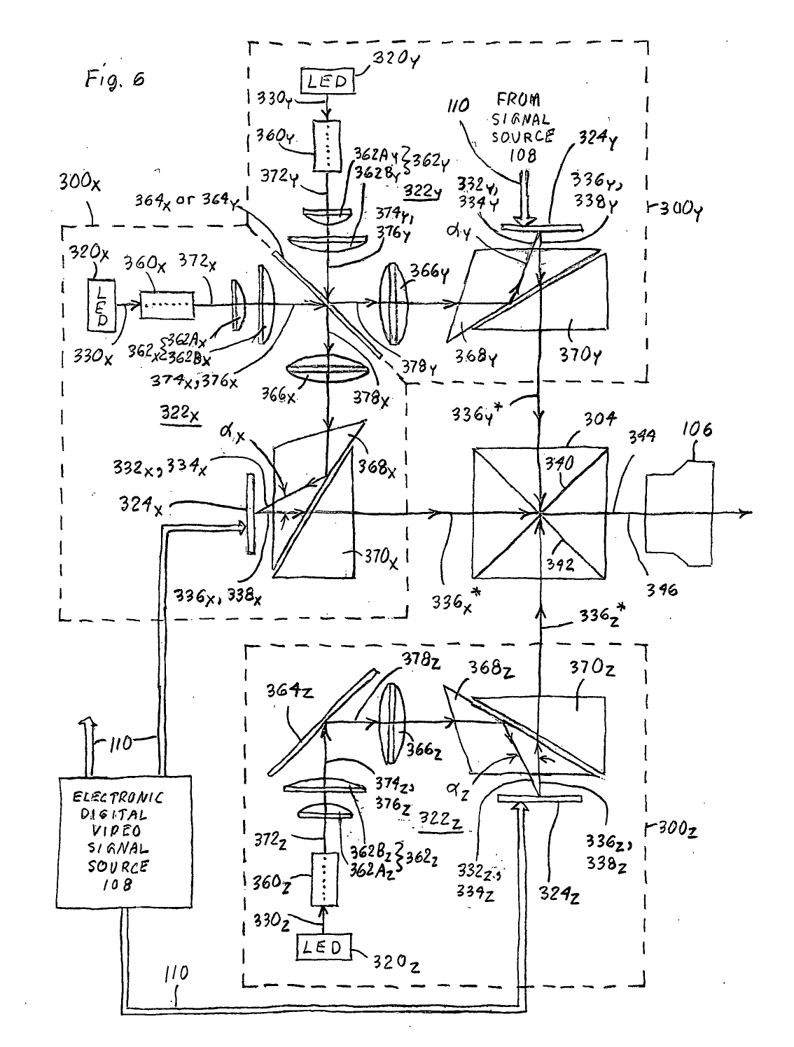

Light-converting structures 322_{X} and 322_{Y} of optical assemblies 300_{X} and 300_{Y} may share some componentry to reduce the total component count. Subject to the potential componentry sharing, each optical assembly 300_{W} in the projector of FIG. 5 is, as indicated by the preceding material, configured and operable substantially the same as first optical assembly 100 in the projector of FIG. 3. The light-conversion function of each light-converting structure 322_{W} typically involves integrating and collimating light of first intermediate color beam 330_{W} and appropriately changing the light propagation direction in producing second intermediate color beam 332_{W}. This is further described below in connection with FIG. 6.

Optical assemblies 300_{Y} and 300_{Z} are situated respectively along a pair of opposite sides of X-cube beam combiner 304 so that assembly output color beams 336_{Y} and 336_{Z} respectively impinges substantially perpendicularly on those two sides of beam combiner 304. Optical assembly 300_{X} is situated along the side of beam combiner 304 opposite projection lens device 106 so that assembly output color beam 336_{X} impinges substantially perpendicularly on that third side of beam combiner 304.

X-cube beam combiner 304 has a pair of dichroic plates (or mirrors) 340 and 342 which intersect at an angle of approximately 90°. Each dichroic plate 340 or 342 is situated at approximately a 45° angle to the main projection optical axis 344 of the projector of FIG. 5. Dichroic plate 340 reflects color light of the wavelength provided by optical assembly 300_{Z} and transmits color light of the wavelengths provided by optical assemblies 300_{X} and 300_{Y}. Dichroic plate 342 reflects light of the wavelength provided by optical assembly 300_{Y} and transmits light of the wavelengths provided by optical assemblies 300_{X} and 300_{Z}.

With optical assemblies 300_{X}, 300_{Y}, and 300_{Z}, X-cube beam combiner 304, and projection lens device 106 arranged in the preceding manner, light of assembly output beam 336_{X}* of color X is transmitted through dichroic plates 340 and 342 so as to travel forward along the main projection axis 344 of the projector of FIG. 5 toward projection lens device 106. Light of assembly output beam 336_{Y}* of color Y is transmitted through dichroic plate 340 and reflected approximately 90° by dichroic plate 342 so as to travel forward along main projection axis 344 toward projection lens device 106. In a complementary manner, light of assembly output beam 336_{Z}* of color Z is transmitted through dichroic plate 342 and reflected approximately 90° by dichroic plate 340 so as to travel forward along main projection axis 344 toward projection lens device 106. Beam combiner 304 thereby combines light of assembly output beams 336_{X}*, 336_{Y}*, and 336_{Z}* to form a composite digitally modulated projector output beam 346 of light of colors X, Y, and Z.

Note that some rays of assembly output beam 336_{Y}* of color Y are first transmitted through dichroic plate 340 and then reflected by dichroic plate 342 while other rays of assembly output beam 336_{Y}* are first reflected by dichroic plate 342 and then transmitted through dichroic plate 340. Similarly, some rays of assembly output beam 336_{Z}* of color Z are first transmitted through dichroic plate 342 and then reflected by dichroic plate 340 while other rays of assembly output beam 336_{Z}* are first reflected by dichroic plate 340 and then transmitted through dichroic plate 342. This difference in the transmission/reflection order for different rays of assembly output beams 336_{Y}* and 336_{Z}* is immaterial to the beam combining function of beam combiner 304.

As mentioned above, light of each modulated further color beam 336_{W} of color W forms modulated assembly output beam 336_{W}* of that color W. Accordingly, beam combiner 304 produces composite modulated light beam 366 of colors X, Y, and Z by combining light of modulated further color beams 336_{X}, 336_{Y}, and 336_{Z}. Projection lens device 106 projects composite projector output color beam 366 onto a suitable imaging surface (again not shown) such as a screen to produce an image, typically time varying, on the imaging surface.

Color X, Y, and Z are typically red, green, and blue in a typical situation for implementing the projector of FIG. 5. That is, optical assembly 300_{X} typically processes a selected one of red, green, and blue light to generate modulated further beam 336_{X} as that selected one of red, green, and blue light. Optical assembly 300_{Y} then processes one of the other two of red, green, and blue light to generate modulated further beam 336_{Y}. Finally, optical assembly 300_{Z} processes the remaining one of red, green, and blue light to generate modulated further beam 336_{Z}. Color X of light processed by optical assembly 300_{X} is preferably green.

FIG. 6 illustrates an implementation of the general three-panel LED-source color light projector of FIG. 5. Implementations of light-converting structures 322_{X}, 322_{Y}, and 322_{Z} are specifically shown in FIG. 6. Again letting W be a letter varying from X to Z, each light-converting structure 322_{W} here consists of a light integrator 360_{W}, a light collimator 362_{W}, a folding mirror (light reflector) 364_{W}, a condenser (relay) lens 366_{W}, and a prism structure formed with an input prism 368_{W} and an output prism 370_{W}. Prisms 360_{W} and 370_{W} in each prism structure are separated from each other by a small space.

Folding mirrors 364_{X} and 364_{Y} in the projector implementation of FIG. 6 are the same folding mirror. That is, folding mirror 363_{X}/364_{Y} is utilized by both of light-converting structures 322_{X} and 322_{Y}, thereby reducing the component count by one.

Subject to the sharing of folding mirror 363_{X}/364_{Y} by light-converting structures 322_{X} and 322_{Y} in the projector implementation of FIG. 6, light integrator 360_{W}, light collimator 362_{W}, folding mirror 364_{W}, condenser lens 366_{W}, input prism 368_{W}, and output prism 370_{W} in each light-converting structure 322_{W} of the implementation of FIG. 6 are respectively configured, interconnected, and operable substantially the same as light integrator 180, light collimator 182, folding mirror 184, condenser lens 186, input prism 188, and output prism 190 in light-converting structure 122 of the projector implementation of FIG. 4. Each light collimator 362_{W} in each light-converting structure 322_{W} of the projector implementation of FIG. 6 thus consists of an input plano-convex collimating lens 362A_{W} and an output plano-convex collimating lens 362B_{W} respectively configured, interconnected, and operable substantially the same as input plano-convex collimating lens 182A and output plano-convex collimating lens 182B in light collimator 182 in light-converting structure 122 of the projector implementation of FIG. 4.

With W being a letter varying from X to Z, reference symbols 372_{W}, 374_{W}, 376_{W}, and 378_{W} for each light-converting structure 322W in the projector implementation of FIG. 6 respectively represent an integrated beam of light of color W, a collimated light beam of color W, a collimation axis for the collimated light beam of color W, and a reflected light beam of color W respectively corresponding to integrated beam 192 of light of color X, collimated light beam 194 of color X, collimation axis 196 for collimated light beam 194 of color X, and reflected light beam 198 of color X for each light-converting structure 122 in the projector implementation of FIG. 4. Based on the meanings assigned to reference symbols 372_{W}, 374_{W}, 376_{W}, and 378_{W} for each light-converting structure 322_{W} in the implementation of FIG. 6 and on the fact that components 360_{W}, 362_{W}, 364_{W}, 366_{W}, 368_{W}, 370_{W} of each light-converting structure 322_{W} in the implementation of FIG. 6 are respectively configured, interconnected, and operable substantially the same as components 180, 182, 184, 186, 188, and 190 of light-converting structure 122 in the implementation of FIG. 4, the configuration and operation of each light-converting structure 322_{W} in the implementation of FIG. 6 is clear.

Color LEDs suitable for implementing color LEDs 120, 140_{Y}, and 140_{Z} in the projector of FIGS. 3 and 4 are typically PhlatLight PT120 LED devices made by Luminus Devices, Inc. The same applies to color LEDs 320_{X}, 320_{Y}, and 320_{Z} in the projector of FIGS. 5 and 6. A chipset of the PhlatLight PT120 LED devices typically contains three LEDs which respectively emit red, green, and blue light.

Offset-angle reflective digital light modulating devices 124 and 144 in the projector of FIGS. 3 and 4 and offset reflective digital light modulating devices 324_{X}, 324_{Y}, and 324_{Z} in the projector of FIGS. 5 and 6 are typically DMDs as generally described in Hornbeck, cited above, the contents of which are incorporated by reference herein. DMDs of the type generally suitable for light modulators 124, 144, 324_{X}, 324_{Y}, and 324_{Z} are further described in Hornbeck, “Digital Light Processing and MEMS: Timely Convergence for a Bright Future”, Procs. SPIE, Micromachining and Microfabrication Process Technology, vol. 2639, 1995, 25 pp., the contents of which are also incorporated by reference herein.

Reflection offset angles α₁ and α₂ of digital light modulating devices 124 and 144 in the projector of FIGS. 3 and 4 are typically largely equal. Reflection offset angles α_{X}, α_{Y}, and α_{Z} of modulating devices 324_{X}, 324_{Y}, and 324_{Z} in the projector of FIGS. 5 and 6 are likewise typically largely equal. Each offset angle α₁, α₂, α_{X}, α_{Y}, or α_{Z} is normally 10°-30°, typically 20° or 24°.

FIG. 7a illustrates an embodiment 380 of each light integrator 180, 200_{Y}, 200_{Z}, 360_{X}, 360_{Y}, or 360_{Z} in the implementation of the LED-source color light projector in FIG. 4 or 6. Light integrator 380 consists of a solid piece of glass having an input end 382 and an output end 384. Rays of the color light of first intermediate beam 130, 150_{Y}, 150_{Z}, 330_{X}, 330_{Y}, or 330_{Z} enter input end 382 traveling in various directions. The color light rays mix as they propagate down integrator 380 toward output end 384. Part of the mixing arises from reflection of the light rays off the side surfaces of integrator 380. The resulting mixed color light rays exit integrator 380 at output end 384 as integrated color light beam 192, 212_{Y}, 212_{Z}, 372_{X}, 372_{Y}, or 372_{Z}.

FIG. 7b illustrates another embodiment 386 of each light integrator 180, 200_{Y}, 200_{Z}, 360_{X}, 360_{Y}, or 360_{Z} in the implementation of the LED-source color light projector in FIG. 4 or 6. Light integrator 386 is a rectangular hollow pipe having an input end 388 and an output end 390. The pipe of integrator 386 is formed with four flat walls 392, 394, 396, and 398, typically glass such as BK7 glass. Rays of the color light of first intermediate beam 130, 150_{Y}, 150_{Z}, 330_{X}, 330_{Y}, or 330_{Z} enter input end 388 traveling in various directions. The color light rays mix as they propagate down integrator 386 toward output end 390. Part of the mixing arises from reflection of the light rays off the internal side surfaces of walls 392, 394, 396, and 398. The mixed color light rays exit integrator 386 at output end 390 as integrated color light beam 192, 212_{Y}, 212_{Z}, 372_{X}, 372_{Y}, or 372_{Z}.

Output end 384 or 390 of light integrator 380 or 386 has a width w and a height h. The aspect ratio w/h at integrator output end 384 or 390 is typically chosen to match the aspect ratio of the image area of digital light modulating devices 124 and 144 in the projector of FIGS. 3 and 4 or digital modulating devices 324_{X}, 324_{Y}, and 324_{Z} in the projector of FIGS. 5 and 6. Although FIGS. 7a and 7b depict light integrators 380 and 386 as having rectangular sides, integrators 380 and 386 may be longitudinally tapered, especially if suitable for matching the light-emitting area of color LED 120, 140_{Y}, 140_{Z}, 320_{X}, 320_{Y}, or 320_{Z}.

While the invention has been described with reference to preferred embodiments, this description is solely for the purpose of illustration and is not to be construed as limiting the scope of the invention claimed below. For instance, dichroic plate 160 in beam combiner 104 in the projector of FIGS. 3 and 4 can be replaced with a dichroic plate constructed so as to largely transmit incident light of the wavelength of colors Y and Z and to largely reflect incident light of the wavelengths of color X. Projection lens device 106 is then moved to a position above beam combiner 104 in FIGS. 3 and 4 so that main projection axis 164 extends vertically.

Output beam 136* of color X provided by first optical assembly 100 in the foregoing modified version of the projector of FIGS. 3 and 4 impinges on the front surface of the modified beam-combiner dichroic plate traveling substantially perpendicular to main projection axis 164. With the modified dichroic plate being at approximately 45° angle to the modified orientation of main projection axis 164, light of assembly output beam 136* is reflected by approximately 90° so as to travel forward along main projection axis 164. Output beam 156* of colors Y and Z provided by second optical assembly 102 impinges on the rear surface of the modified dichroic plate traveling forward substantially along main projection axis 164. Light of assembly output beam 156* is thereby largely transmitted through the modified dichroic plate without significant change of direction. Light of both of assembly output beams 136* and 156* is again combined by beam combiner 104 to form composite digitally modulated projector output beam 166 of light of colors X, Y, and Z.

Second optical assembly 102 in the projector of FIGS. 3 and 4 can be extended to include LEDs of three or more different colors. LED controller 146 is then modified so to enable only one of the three of more LEDs to be on at any time. Each offset-angle reflective light modulating device 124 or 144 in the two-panel projector of FIGS. 3 and 4 can be replaced with a reflective light modulating device, such as a reflective liquid-crystal display light modulator, in which reflection axis 138 or 158 is largely identical to incident axis 134 or 154. That is, reflection offset angle α₁ or α₂ can be reduced to zero in the two-panel projector of FIGS. 3 and 4. FIGS. 3 and 4 illustrate main reflection axes 138 and 158 of light modulating devices 124 and 144 as extending generally perpendicular to their front surfaces. FIGS. 5 and 6 similarly illustrate main reflection axes 338_{X}, 338_{Y}, and 338_{Z} of modulating devices 324_{X}, 324_{Y}, and 324_{Z} as extending generally perpendicular to their front surfaces. However, reflection axes 138, 158, 338_{X}, 338_{Y}, and 338_{Z} can extend in other directions relative to the front surfaces of light modulators 124, 144, 324_{X}, 324_{Y}, and 324_{Z} as long as their reflection offset angles α₁, α₂, α_{X}, α_{Y}, and α_{Z} are at suitable non-zero values.

Folding mirror 184 can be deleted in first light-converting structure 122 of first optical assembly 100 in the projector implementation of FIG. 4 provided that the optical path length of the light of output beam 136* of color X is not significantly changed. In that case, collimated light beam 194 of color X is relayed by first condenser lens 186 to first input prism 188.

Letting W again be a letter varying from X to Z, folding mirror 364_{W} can similarly be deleted in light-converting structure 322_{W} of each optical assembly 300_{W} in the projector implementation of FIG. 6 provided that the optical path length of the light of output beam 336_{W}* of color W is not significantly altered. Collimated light beam 374_{W} of color W is then relayed by condenser lens 366_{W} to input prism 368_{W}. In so deleting common folding mirror 364_{X}/364_{Y} from optical assemblies 300_{X} and 300_{Y}, the arrangement of the components of optical assembly 300_{X} or/and optical assembly 300_{Y} may have to be modified to avoid having optical assemblies 300_{X} and 300_{Y} physically interfere with each other. For example, the components of optical assembly 300_{Y} can be arranged in a mirror image of what arises from simply deleting folding mirror 364_{X}/364_{Y}.

Common folding mirror 364_{X}/364_{Y} in the projector implementation of FIG. 6 can be replaced with separate folding mirrors. Color LEDs 120, 140_{Y}, 140_{Z}, 320_{X}, 320_{Y} and 320_{Z} in the projectors of the invention can also variously handle infrared light for reduced lighting situations such as night-vision applications. Various modifications and applications may thus be made by those skilled in the art without departing from the true scope of the invention as defined in the appended claims.

I claim:

1. A light projector for projecting an image of color light in response to an electronic digital video signal, the projector comprising:
a first optical assembly comprising:
a first light-emitting diode for emitting light of a first selected color to produce a first intermediate beam of light of the first selected color;
first light-converting structure for converting the first intermediate beam of the first selected color into a second intermediate beam of light of the first selected color; and
a first modulating device responsive to the digital video signal for reflectively modulating the second intermediate beam of the first selected color as that beam travels generally along a first incident axis to produce a digitally modulated further beam of light of the first selected color traveling generally along a first reflection axis at a first non-zero offset angle to the first incident axis;
a second optical assembly comprising:
a plural number of second light-emitting diodes for emitting light of a like plural number of respective second selected colors to respectively produce a like plural number of first intermediate beams of light of the second selected colors;
second light-converting structure for converting the first intermediate beams of the second selected colors respectively into a like plural number of second intermediate beams of light of the second selected colors; and
a second modulating device responsive to the digital video signal for reflectively modulating the second intermediate beams of the second selected colors as those beams travel generally along a second incident axis to respectively produce a like plural number of digitally modulated further beams of light of the second selected colors traveling generally along a second reflection axis at a second non-zero offset angle to the second incident axis, each selected color being different from each other selected color;
a beam combiner for combining light of the further beams to produce a composite digitally modulated beam of light of the selected colors; and
a projection lens device for projecting light of the composite beam.

2. A projector as in claim 1 wherein:
the first reflection axis is at a first non-zero offset angle to the first incident axis; and
the second reflection axis is at a second non-zero offset angle to the second incident axis.

3. A projector as in claim 2 wherein the offset angle of each modulating device is at least 10°.

4. A projector as in claim 2 wherein each modulating device comprises a digital micromirror device.

5. A projector as in claim 2 further including a control device for causing each second light-emitting diode to switch between light-emissive and non-light-emissive states at a selected duty cycle.

6. A projector as in claim 2 wherein:
the first selected color is green; and
the plural number is two whereby there are two second selected colors, the two second selected colors being red and blue.

7. A projector as in claim 2 wherein the light-converting structures integrate light of their first intermediate beams for causing their second intermediate beams to be respectively of more uniform areal illumination intensity than their first intermediate beams.

8. A projector as in claim 2 wherein the light-converting structures collimate light of their first intermediate beams for causing light of their second intermediate beams to be largely collimated.

9. A projector as in claim 8 wherein:
the first optical assembly causes collimated light of its first intermediate beam to travel generally along a first collimation axis, materially different from the first incident axis, immediately after light of its first intermediate beam is collimated; and
the second optical assembly causes collimated light of its first intermediate beams to travel generally along at least one second collimation axis, materially different from the second incident axis, immediately after light of its first intermediate beams is collimated.

10. A projector as in claim 9 wherein the light-converting structures reflectively direct collimated light of their first intermediate beams.

11. A projector as in claim 9 wherein the modulating devices reflectively modulate their second intermediate beams according to pulse-width modulation in respectively producing their further beams.

12. A projector as in claim 9 wherein the second optical assembly (i) causes collimated light of its first intermediate beams to initially travel respectively along a like plural number of different such collimation axes, (ii) subsequently operates on that light to cause collimated light of its first intermediate beams to later travel generally along a further axis, and (iii) converts the collimated light of its first intermediate beams traveling along the further axis respectively into its second intermediate beams traveling along the second incident axis.

13. A projector as in claim 12 wherein:
the first selected color is green;
the plural number is two whereby the second optical assembly has two second light-emitting diodes for emitting light of two second selected colors to respectively produce two first intermediate beams of light of the two second selected colors;
the two second selected colors are red and blue whereby the two first intermediate beams of the second optical assembly are respectively constituted with red and blue light; and
the further axis is largely coincident with the collimation axis of the collimated light of the second assembly's first intermediate beam of red light.

14. A projector as in claim 2 wherein the light-converting structures cause light of the second intermediate beams to be respectively of largely the same optical path length across their beam areas.

15. A light projector for projecting an image of color light in response to an electronic digital video signal, the projector comprising:
a plurality of optical assemblies, each comprising:
a light-emitting diode for emitting light of a selected color to produce a first intermediate beam of light of the selected color;
light-converting structure for converting the first intermediate beam into a second intermediate beam of light of the selected color; and
a modulating device responsive to the digital video signal for reflectively modulating the second intermediate beam as it travels generally along an incident axis to produce a digitally modulated further beam of light of the selected color traveling generally along a reflection axis at a non-zero offset angle to the incident axis, each selected color being different from each other selected color;
a beam combiner for combining light of the further beams to produce a composite digitally modulated beam of light of the selected colors; and
a projection lens device for projecting light of the composite beam.

16. A projector as in claim 15 wherein each modulating device comprises a digital micromirror device.

17. A projector as in claim 15 wherein the plurality of optical assemblies is three optical assemblies whereby there are three selected colors, the three selected colors being red, green, and blue.

18. A projector as in claim 15 wherein the light-converting structure of each optical assembly integrates light of its first intermediate beam for causing its second intermediate beam to be of more uniform areal illumination intensity than its first intermediate beam.

19. A projector as in claim 15 wherein the light-converting structure of each optical assembly collimates light of its first intermediate beam for causing light of its second intermediate beam to be largely collimated.

20. A projector as in claim 19 wherein each optical assembly causes collimated light of its first intermediate beam to travel generally along a collimation axis, materially different from its incident axis, immediately after light of its first intermediate beam is collimated.

21. A projector as in claim 20 wherein the light-converting structure of each optical assembly reflectively directs collimated light of its first intermediate beam.

22. A projector as in claim 20 wherein the modulating device of each optical assembly reflectively modulates its second intermediate beam according to pulse-width modulation in producing its further beam.

23. A method of projecting an image of color light in response to an electronic digital video signal, the method comprising:
performing a first light-processing act comprising:
causing a first light-emitting diode to emit light of a first selected color for producing a first intermediate beam of light of the first selected color;
converting the first intermediate beam of the first selected color into a second intermediate beam of light of the first selected color; and
reflectively modulating the second intermediate beam of the first selected color in response to the digital video signal as the second intermediate beam of the first selected color travels generally along a first incident axis to produce a digitally modulated further beam of light of the first selected color traveling generally along a first reflection axis;
performing a second light-processing act comprising:
causing a plural number of second light-emitting diodes to emit light of a like plural number of respective second selected colors for respectively producing a like plural number of first intermediate beams of light of the second selected colors;
respectively converting the first intermediate beams of the second selected colors respectively into a like plural number of second intermediate beams of light of the second selected colors; and
reflectively modulating the second intermediate beams of the second selected colors in response to the digital video signal as the second intermediate beams of the second selected colors travel generally along a second incident axis to respectively produce a like plural number of digitally modulated further beams of light of the second selected colors traveling generally along a second reflection axis, each selected color being different from each other selected color;
combining light of the further beams to produce a composite digitally modulated beam of light of the selected colors; and
projecting light of the composite beam onto a screen.

24. A method as in claim 1 wherein:
the first reflection axis at a first non-zero offset angle to the first incident axis; and
the second reflection axis at a second non-zero offset angle to the second incident axis.

25. A method as in claim 24 wherein each of the first and second offset angles is at least 10°.

26. A method as in claim 24 wherein:
the first selected color is green; and
the plural number is two whereby there are two second selected colors, the two second selected colors being red and blue.

27. A method as in claim 24 wherein the converting acts comprise integrating light of the first intermediate beams for causing the second intermediate beams to be respectively of more uniform areal illumination intensity than the first intermediate beams.

28. A method as in claim 24 wherein the converting acts comprise collimating light of the first intermediate beams for causing light of the second intermediate beams to be largely collimated.

29. A method as in claim 28 wherein:
the act of converting the first intermediate beam of the first selected color includes causing collimated light of that beam to travel generally along a first collimation axis, materially different from the first incident axis, immediately after light of that beam is collimated; and
the act of converting the first intermediate beams of the second selected colors includes causing collimated light of those beams to travel generally along at least one second collimation axis, materially different from the second incident axis, immediately after light of those beams is collimated.

30. A method as in claim 29 wherein the reflectively modulating acts include modulating the second intermediate beams according to pulse-width modulation in respectively producing the further beams.

31. A method as in claim 29 wherein the act of converting the first intermediate beams of the second selected colors comprises (i) causing collimated light of the first intermediate beams of the second selected colors to initially travel respectively along a like plural number of different such collimation axes, (ii) subsequently operating on that light to cause collimated light of the first intermediate beams of the second selected colors to later travel generally along a further axis, and (iii) converting the collimated light of the first intermediate beams of the second selected colors traveling along the further axis respectively into the second intermediate beams of the second selected colors traveling along the second incident axis.

32. A method as in claim 29 further including switching each second light-emitting diode between light-emissive and non-light-emissive states at a selected duty cycle.

33. A method of projecting an image of color light in response to an electronic digital video signal, the method comprising:
performing a plurality of light-processing acts, each comprising:
causing a light-emitting diode to emit light of a selected color for producing a first intermediate beam of light of the selected color;
converting the first intermediate beam into a second intermediate beam of light of the selected color; and
reflectively modulating the second intermediate beam in response to the digital video signal as the second intermediate beam travels generally along an incident axis to produce a digitally modulated further beam of light of the selected color traveling generally along a reflection axis at a non-zero offset angle to the incident axis, each selected color being different from each other selected color;
combining light of the further beams to produce a composite digitally modulated beam of light of the selected colors; and
projecting light of the composite beam onto a screen.

34. A method as in claim 33 wherein the plurality of light-processing acts is three light-processing acts whereby there are three selected colors, the three selected colors being red, green, and blue.

35. A method as in claim 33 wherein the converting acts comprise integrating light of the first intermediate beams for causing the second intermediate beams to be respectively of more uniform areal illumination intensity than the first intermediate beams.

36. A method as in claim 33 wherein the converting acts comprise collimating light of the first intermediate beams for causing light of the second intermediate beams to be largely collimated.
